(19) United States
(12) Patent Application Publication
(10) Pub. No.: US 2016/0104592 A1
(43) Pub. Date: Apr. 14, 2016

(54) Contactor Drive Circuit

(71) Applicant: Huawei Technologies Co., Ltd., Shenzhen (CN)

(72) Inventors: Boning Huang, Shenzhen (CN); Jing Yang, Shenzhen (CN); Peng Zhang, Shenzhen (CN)

(21) Appl. No.: 14/956,881

(22) Filed: Dec. 2, 2015

Related U.S. Application Data
(63) Continuation of application No. PCT/CN2015/072569, filed on Feb. 9, 2015.

(30) Foreign Application Priority Data
May 27, 2014 (CN) 201410228099.0

(51) Int. Cl. H01H 47/22

(52) U.S. Cl. CPC H01H 47/226

(57) ABSTRACT

A contactor drive circuit includes a power supply, a processor, a line connection and control unit, a first drive end, and a second drive end; when a contactor is connected between the first drive end and the second drive end, the processor determines, according to a value of a current flowing through the contactor, a type of the contactor connected between the first drive end and the second drive end; and according to a result of the determining, the processor controls the line connection and control unit to enable the first drive end to be electrically connected to an anode of the power supply, and controls the second drive end to be electrically connected to a cathode of the power supply.

### CROSS-REFERENCE TO RELATED APPLICATIONS

This application is a continuation of International Application No. PCT/CN2015/072569, filed on Feb. 9, 2015, which claims priority to Chinese Patent Application No. 201410228099.0, filed on May 27, 2014, both of which are hereby incorporated by reference in their entireties.

### TECHNICAL FIELD

The present disclosure relates to the field of drive, and in particular, to a contactor drive circuit.

### BACKGROUND

In current industrial control application, generally, a weak-current component is configured to control a strong-current component, and a low-current device is configured to control a high-current device. As a weak-current component, a contactor is often configured to control another component that has a strong current. Contactors include a normally closed contactor, a bistable contactor, and the like. The normally closed contactor generally is in a closed state, and after changing from the closed state to an open state, the normally closed contactor needs externally provided electrical power to keep in the open state. However, for the bistable contactor, the bistable contactor not only can work in a normally open state but also can work in a normally closed state, and can keep in the normally open state or the normally closed state without externally provided electrical power. In the prior art, an ordinary contactor drive circuit generally can only drive a contactor of a single type, for example, a contactor drive circuit that drives a normally closed contactor generally cannot drive a bistable contactor, and a contactor drive circuit that drives a bistable contactor generally cannot drive a normally closed contactor.

### SUMMARY

A contactor drive circuit is provided, which can drive a bistable contactor and a normally closed contactor.

According to a first aspect, a contactor drive circuit is provided, configured to drive a bistable contactor or a normally closed contactor, where the contactor drive circuit includes a power supply, a processor, a line connection and control unit, a first drive end, and a second drive end, where the first drive end and the second drive end are configured to drive the bistable contactor or the normally closed contactor, and the processor is electrically connected to the line connection and control unit. When a contactor is connected between the first drive end and the second drive end, the processor determines, according to a value of a current flowing through the contactor, a type of the contactor connected between the first drive end and the second drive end; and according to a result of the determining, controls the line connection and control unit to enable the first drive end to be electrically connected to an anode of the power supply, and controls the second drive end to be electrically connected to a cathode of the power supply; or controls the line connection and control unit to enable the second drive end to be connected to the anode of the power supply, and controls the first drive end to be connected to the cathode of the power supply.

In a first implementation manner, the contactor drive circuit further includes a first switch unit and a second switch unit, where the first switch unit and the second switch unit are electrically connected to the processor, and the processor controls the second switch unit to be conducted and the first switch unit to be disconnected, to control the second drive end to be electrically connected to the cathode of the power supply; or the processor controls the first switch unit to be conducted and the second switch unit to be disconnected, to control the first drive end to be connected to the cathode of the power supply.

With reference to the first implementation manner, in a second implementation manner, the line connection and control unit is a relay, where the relay includes a first normally closed contact, a second normally closed contact, a first normally open contact, a second normally open contact, a first common contact, a second common contact, and a coil, where the first normally closed contact and the second normally open contact are connected to the anode of the power supply, the first normally open contact is connected to the cathode of the power supply using the first switch unit, the second normally closed contact is connected to the cathode of the power supply using the second switch unit, the first common contact is connected to the first drive end, the second common contact is connected to the second drive end, one end of the coil is electrically connected to the processor, and the other end of the coil is grounded; when the contactor is connected between the first drive end and the second drive end, the processor determines, according to the value of the current flowing through the contactor, the type of the contactor connected between the first drive end and the second drive end; and according to the result of the determining, the processor controls the first common contact to be electrically connected to the first normally closed contact and the second common contact to be electrically connected to the second normally closed contact, such that the first drive end is electrically connected to the anode of the power supply; or the processor controls the first common contact to be electrically connected to the first normally open contact and the second common contact to be electrically connected to the second normally open contact, such that the second drive end is electrically connected to the anode of the power supply.

With reference to the second implementation manner, in a third possible implementation manner, when the processor determines that the type of the contactor connected between the first drive end and the second drive end is a bistable contactor, where the bistable contactor includes an auxiliary contact, where the auxiliary contact indicates a current working state of the bistable contactor, the processor controls, according to the current working state of the bistable contactor, the first common contact to be electrically connected to the first normally closed contact and the second common contact to be electrically connected to the second normally closed contact, and controls the second switch unit to be conducted and the first switch unit to be disconnected, to control the bistable contactor to switch from a first working state to a second working state; and the processor controls, according to the current working state of the bistable contactor, the first common contact to be electrically connected to the first normally open contact and the second common contact to be electrically connected to the second normally open contact, and controls the first switch unit to be conducted and the second switch unit to be disconnected, to control the bistable contactor to switch from the second working state to the first working state.

With reference to the second or third possible implementation manner, in a fourth possible implementation manner, a signal used for the processor to control the first switch unit is a first control signal, and when the first control signal controls the first switch unit to be conducted, a start time of the first control signal is a first start time, and an end time of the first control signal is a first end time; and a signal used for the processor to control the relay is a third control signal, and when the third control signal controls the first common contact to be electrically connected to the first normally open contact and the second common contact to be electrically connected to the second normally open contact, a start time of the third control signal is a second start time, and an end time of the third control signal is a second end time, where the first start time is a first time interval later than the second start time, and the second end time is a second time interval later than the first end time.

With reference to the fourth possible implementation manner, in a fifth possible implementation manner, the first time interval is equal to the second time interval.

With reference to the fifth possible implementation manner, in a sixth possible implementation manner, the first time interval and the second time interval are 200 milliseconds (ms).

With reference to any possible implementation manner in the second to sixth possible implementation manners, in a seventh possible implementation manner, when the processor determines that the type of the contactor connected between the first drive end and the second drive end is a normally closed contactor, the processor controls the first common contact to be electrically connected to the first normally closed contact and the second common contact to be electrically connected to the second normally closed contact, and controls the second switch unit to be conducted and the first switch unit to be disconnected, to enable the second drive end to be connected to the cathode of the power supply, so as to drive the normally closed contactor; or controls the first common contact to be electrically connected to the first normally open contact and the second common contact to be electrically connected to the second normally open contact, and controls the first switch unit to be conducted and the second switch unit to be disconnected, to enable the first drive end to be connected to the cathode of the power supply, so as to drive the normally closed contactor.

With reference to the seventh possible implementation manner, in an eighth possible implementation manner, the signal used for the processor to control the first switch unit is the first control signal, and when the first control signal controls the first switch unit to be conducted, the start time of the first control signal is a third start time; and the signal used for the processor to control the relay is the third control signal, and when the third control signal controls the first common contact to be electrically connected to the first normally open contact and the second common contact to be electrically connected to the second normally open contact, the start time of the third control signal is a fourth start time, where the third start time is a third time interval later than the fourth start time.

With reference to the eighth possible implementation manner, in a ninth possible implementation manner, the third time interval is 200 ms.

With reference to the first aspect and any one of the first to ninth possible implementation manners, in a tenth possible implementation manner, the contactor drive circuit further includes a first resistor and a first sampling circuit, where one end of the first resistor is connected to the cathode of the power supply, the other end of the first resistor is connected to one end of the first sampling circuit, the other end of the sampling circuit is connected to the processor, and a node between the first resistor and the first sampling circuit is connected to the anode of the power supply; the first sampling circuit detects a value of a current flowing through the first resistor, and transmits, to the processor, the detected value of the current flowing through the first resistor, and the processor determines, according to the value of the current flowing through the first resistor, whether the contactor currently driven by the contactor drive circuit is a normally closed contactor or a bistable contactor.

With reference to any one of the second to tenth possible implementation manners, in an eleventh possible implementation manner, the first switch unit includes a first control end, a first conducting end, and a second conducting end, where the first control end is connected to the processor, and controls, under the control of the processor, the first conducting end and the second conducting end to be conducted or cut off, to implement conduction or disconnection of the first switch unit; where the first conducting end is connected to the first normally open contact, and the second conducting end is connected to the cathode of the power supply.

With reference to the eleventh possible implementation manner, in a twelfth possible implementation manner, the contactor drive circuit further includes a first voltage regulator tube and a second voltage regulator tube, where a cathode of the first voltage regulator tube is connected to a node between the first normally open contact and the first conducting end, an anode of the first voltage regulator tube is connected to an anode of the second voltage regulator tube, and a cathode of the second voltage regulator tube is connected to the cathode of the power supply.

With reference to the eleventh possible implementation manner or the twelfth possible implementation manner, in a thirteenth possible implementation manner, the first switch unit is an N-channel field effect transistor, the first control end is a gate of the N-channel field effect transistor, the first conducting end is a drain of the N-channel field effect transistor, and the second conducting end is a source of the N-channel field effect transistor.

With reference to any one of the second to thirteenth possible implementation manners, in a fourteenth possible implementation manner, the second switch unit includes a second control end, a third conducting end, and a fourth conducting end, where the second control end is connected to the processor, and controls, under the control of the processor, the third conducting end and the fourth conducting end to be conducted or cut off, to implement conduction or disconnection of the second switch unit; where the third conducting end is connected to the second normally closed contact, and the fourth conducting end is connected to the cathode of the power supply.

With reference to the fourteenth possible implementation manner, in a fifteenth possible implementation manner, the contactor drive circuit further includes a third voltage regulator tube and a fourth voltage regulator tube, where a cathode of the third voltage regulator tube is connected to a node between the second normally closed contact and the third conducting end, an anode of the third voltage regulator tube is connected to an anode of the fourth voltage regulator tube, and a cathode of the fourth voltage regulator tube is connected to the cathode of the power supply.

With reference to the fourteenth or fifteenth possible implementation manner, in a sixteenth possible implementation manner, the second switch unit is an N-channel field effect transistor, the second control end is a gate of the N-channel field effect transistor, the third conducting end is a drain of the N-channel field effect transistor, and the fourth conducting end is a source of the N-channel field effect transistor.

With reference to the first aspect and any one of the first to sixteenth possible implementation manners, in a seventeenth possible implementation manner, the contactor drive circuit further includes a first diode, where an anode of the first diode is connected to the first drive end, and a cathode of the first diode is connected to the anode of the power supply.

With reference to the first aspect and any one of the first to seventeenth possible implementation manners, in an eighteenth possible implementation manner, the contactor drive circuit further includes a second diode, where an anode of the second diode is connected to the second drive end, and a cathode of the second diode is connected to the anode of the power supply.

With reference to any one of the second to eighteenth possible implementation manners, in a nineteenth possible implementation manner, the contactor drive circuit further includes a second sampling circuit, where the second sampling circuit is electrically connected between the processor and a node between the first switch unit and the first normally open contact, to collect a first voltage signal that is at the node between the first normally open contact and the first switch unit; and transmits the first voltage signal to the processor, and the processor compares the first voltage signal with a first preset voltage signal prestored in the processor, to determine whether the first switch unit is faulty, where the first preset voltage signal is a voltage signal representing that the first switch unit works normally.

With reference to any one of the second to nineteenth possible implementation manners, in a twentieth possible implementation manner, the contactor drive circuit further includes a third sampling circuit, where the third sampling circuit is electrically connected between the processor and a node between the second switch unit and the second normally closed contact, to collect a second voltage signal that is at the node between the second normally closed contact and the second switch unit; and transmits the second voltage signal to the processor, and the processor compares the second voltage signal with a second preset voltage signal prestored in the processor, to determine whether the second switch unit is faulty, where the second preset voltage signal is a voltage signal representing that the second switch unit works normally.

According to the contactor drive circuit provided in the present disclosure, a processor first determines a type of a contactor connected between a first drive end and a second drive end. Then the processor controls, according to a result of the determining, a line connection and control unit to enable the first drive end to be electrically connected to an anode of the power supply, controls the second drive end to be connected to a cathode of a power supply, and when the contactor is connected between the first drive end and the second drive end, a current flowing from the first drive end to the second drive end is formed. Alternatively, the processor controls the line connection and control unit to enable the second drive end to be electrically connected to the anode of the power supply, controls the first drive end to be electrically connected to the cathode of the power supply, and when the contactor is connected between the first drive end and the second drive end, a current flowing from the second drive end to the first drive end is formed. In this way, two different types of contractors, that is, a bistable contactor and a normally closed contactor, can be driven. Therefore, a technical effect that one drive circuit drives two different types of contactors is achieved.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic structural diagram of a contactor drive circuit according to an exemplary implementation manner of the present disclosure;

FIG. 2 is a waveform diagram of a first control signal and a third control signal when a contactor drive circuit drives a bistable contactor according to the present disclosure;

FIG. 3 is a schematic diagram of a direction of current flow under the control of the control signals shown in FIG. 2 in a contactor drive circuit according to the present disclosure;

FIG. 4 is a waveform diagram of a second control signal and a third control signal when a contactor drive circuit drives a bistable contactor according to the present disclosure;

FIG. 5 is a schematic diagram of a direction of current flow under the control of the control signals shown in FIG. 4 in a contactor drive circuit according to the present disclosure;

FIG. 6 is a waveform diagram of a first control signal and a third control signal when a contactor drive circuit drives a normally closed contactor according to the present disclosure; and

FIG. 7 is a schematic diagram of a direction of current flow under the control of the control signals shown in FIG. 6 in a contactor drive circuit according to the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

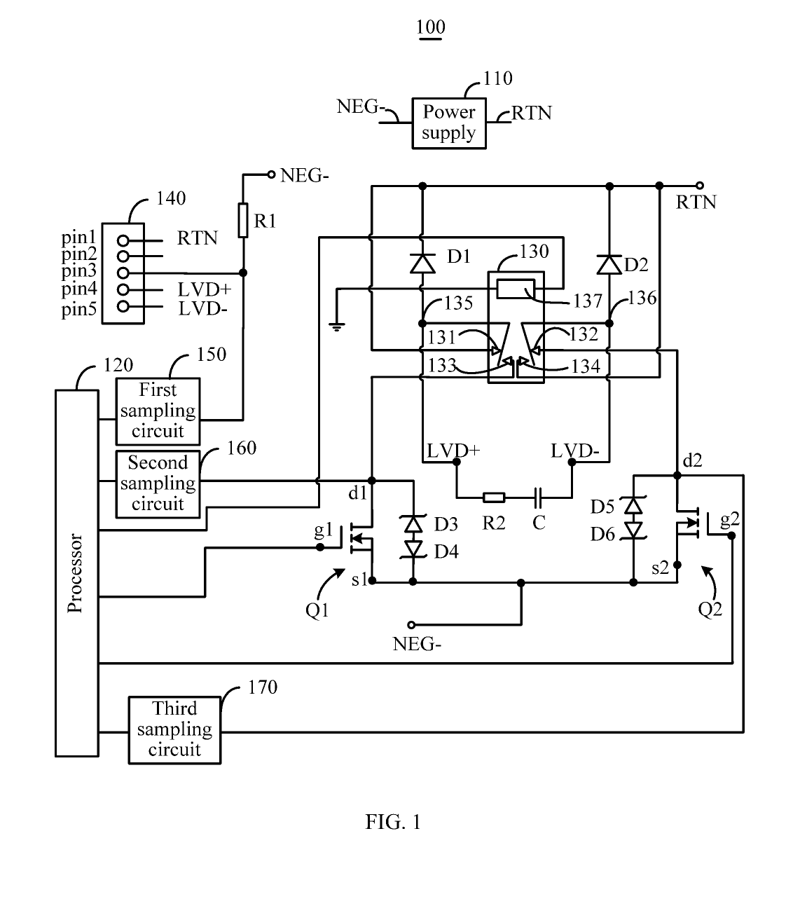

Referring to FIG. 1, FIG. 1 is a schematic structural diagram of a contactor drive circuit according to an exemplary implementation manner of the present disclosure. The contactor drive circuit 100 includes a power supply 110, a processor 120, a line connection and control unit 130, a first drive end LVD+, and a second drive end LVD−. The power supply 110 includes an anode RTN and a cathode NEG−, and the power supply 110 is configured to generate electrical power, which is output by the anode RTN and the cathode NEG−. The first drive end LVD+ and the second drive end LVD− are configured to connect to a bistable trigger or a normally closed trigger. The processor 120 is electrically connected to the line connection and control unit 130; when a contactor is connected between the first drive end LVD+ and the second drive end LVD−, the processor 120 determines, according to a value of a current flowing through the contactor, a type of the contactor connected between the first drive end LVD+ and the second drive end LVD−, and according to a result of the determining, the processor 120 controls the line connection and control unit 130 to enable the first drive end LVD+ to be electrically connected to the anode RTN of the power supply 110, and controls the second drive end LVD− to be electrically connected to the cathode NEG− of the power supply 110; or the processor 120 controls the line connection and control unit 130 to enable the second drive end LVD− to be connected to the anode RTN of the power supply 110, and controls the first drive end LVD+ to be electrically connected to the cathode NEG− of the power supply 110.

The contactor drive circuit 100 further includes a first switch unit Q1 and a second switch unit Q2. The first switch unit Q1 and the second switch unit Q2 are separately electrically connected to the processor 120, and conducted or disconnected under the control of the processor 120. When the processor 120 controls the second switch unit Q2 to be conducted, and controls the first switch unit Q1 to be disconnected, the second drive end LVD− is electrically connected to the cathode NEG− of the power supply 110; or when the processor 120 controls the first switch unit Q1 to be conducted, and controls the second switch unit Q2 to be disconnected, the first drive end LVD+ is electrically connected to the cathode NEG− of the power supply 110.

The line connection and control unit 130 is a relay, and includes a first normally closed contact 131, a second normally closed contact 132, a first normally open contact 133, a second normally open contact 134, a first common contact 135, a second common contact 136, and a coil 137. The first normally closed contact 131 and the second normally open contact 134 are connected to the anode RTN of the power supply 110. The first normally open contact 133 is connected to the cathode NEG− of the power supply 110 using the first switch unit Q1, and the second normally closed contact 132 is connected to the cathode NEG− of the power supply 110 using the second switch unit Q2. The first common contact 135 is connected to the first drive end LVD+, and the second common contact 136 is connected to the second drive end LVD−. One end of the coil 137 is connected to the processor 120, and the other end of the coil 137 is grounded. The processor 120 is further connected to the first switch unit Q1 and the second switch unit Q2. When the contactor is connected between the first drive end LVD+ and the second drive end LVD−, the processor 120 determines, according to the value of the current flowing through the contactor, the type of the contactor connected between the first drive end LVD+ and the second drive end LVD−, and controls, according to the result of the determining, the first common contact 135 to be electrically connected to the first normally closed contact 131 and the second common contact 136 to be electrically connected to the second normally closed contact 132, such that the first drive end LVD+ is electrically connected to the anode RTN of the power supply 110; and controls the second switch unit Q2 to be conducted and the first switch unit Q1 to be disconnected, such that the second drive end LVD− is connected to the cathode NEG− of the power supply 110. Alternatively, the processor 120 controls, according to the result of the determining, the first common contact 135 to be electrically connected to the first normally open contact 133 and the second common contact 136 to be electrically connected to the second normally open contact 134, such that the second drive end LVD− is electrically connected to the anode RTN of the power supply 110; and controls the first switch unit Q1 to be conducted and the second switch unit Q2 to be disconnected, such that the first drive end LVD+ is connected to the cathode NEG− of the power supply 110. In an implementation manner, a value of a voltage of the power supply 110 is 48 volts (V).

When the processor 120 determines that the type of the contactor connected between the first drive end LVD+ and the second drive end LVD− is a bistable trigger, the processor 120 controls, according to a current working state of the bistable trigger, the first common contact 135 to be electrically connected to the first normally closed contact 131 and the second common contact 136 to be electrically connected to the second normally closed contact 132, and controls the second switch unit Q2 to be conducted and the first switch unit Q1 to be disconnected, so as to control the bistable contactor to switch from a first working state to a second working state. The processor 120 controls, according to the current working state of the bistable contactor, the first common contact 135 to be electrically connected to the first normally open contact 133 and the second common contact 136 to be electrically connected to the second normally open contact 134, and controls the first switch unit Q1 to be conducted and the second switch unit Q2 to be disconnected, so as to control the bistable contactor to switch from the second working state to the first working state. Because the bistable contactor includes an auxiliary contact, and the auxiliary contact is configured to indicate the current working state of the bistable contactor, such that the bistable contactor can send the current working state of the bistable contactor to the processor 120.

In this implementation manner, the first working state is an open state, and the second working state is a closed state. In another implementation manner, the first working state is a closed state, and the second working state is an open state. Whether the first working state is an open state (correspondingly, in this case, the second working state is a closed state) or a closed state (correspondingly, in this case, the second working state is an open state) is related to a connection relationship between an anode and a cathode of a drive coil of the bistable trigger and the first drive end LVD+ and between the anode and the cathode of the drive coil of the bistable trigger and the second drive end LVD−. When the anode of the drive coil of the bistable trigger is electrically connected to the first drive end LVD+, and the cathode of the drive coil the bistable trigger is electrically connected to the second drive end LVD−, the first working state is an open state, and the second working state is a closed state. When the cathode of the drive coil of the bistable trigger is electrically connected to the first drive end LVD+, and the anode of the drive coil the bistable trigger is electrically connected to the second drive end LVD−, the first working state is a closed state, and the second working state is an open state.

A process of driving the bistable contactor by the contactor drive circuit 100 is introduced in the following using an example in which the first working state is an open state, and the second working state is a closed state.

When the contactor drive circuit 100 drives the bistable contactor J1, the anode of the drive coil of the bistable trigger J1 is electrically connected to the first drive end LVD+, and the cathode of the drive coil of the bistable trigger J1 is electrically connected to the second drive end LVD−. The processor 120 controls the first switch unit Q1 to be conducted and the second switch unit Q2 to be disconnected, and controls the first common contact 135 to be electrically connected to the first normally open contact 133 and the second common contact 136 to be electrically connected to the second normally open contact 134. In this case, the first drive end LVD+ is electrically connected to the cathode NEG− of the power supply 110. A current formed by the drive coil of the bistable contactor J1 flows from the second drive end LVD− to the first drive end LVD+, and the bistable contactor J1 switches from a closed state to an open state.

When the contactor drive circuit 100 drives the bistable contactor J1, the anode of the drive coil of the bistable contactor J1 is electrically connected to the first drive end LVD+, and the cathode of the drive coil of the bistable trigger J1 is electrically connected to the second drive end LVD−. The processor 120 controls the first switch unit Q1 to be disconnected and the second switch unit Q2 to be conducted, and controls the first common contact 135 to be electrically connected to the first normally closed contact 131 and the second common contact 136 to be electrically connected to the second normally closed contact 132. The second drive end LVD− is electrically connected to the cathode NEG− of the power supply 110. A current formed by the drive coil of the bistable contactor J1 flows from the first drive end LVD+ to the second drive end LVD−, and the bistable contactor J1 switches from an open state to a closed state.

For ease of description, in the following, signals, controlled by the processor 120, of the first switch unit Q1, the second switch unit Q2, and the relay Q3 are respectively named a first control signal, a second control signal, and a third control signal.

The first switch unit Q1 includes a first control end g1, a first conducting end d1, and a second conducting end s1. The first control end g1 is connected to the processor 120, and controls, under the control of the processor 120, the first conducting end d1 and the second conducting end s1 to be conducted or cut off, to implement conduction or disconnection of the first switch unit Q1. The first control end g1 receives the first control signal to control the first conducting end d1 and the second conducting end s1 to be conducted or cut off. The first conducting end d1 is connected to the first normally open contact 133, and the second conducting end s1 is connected to the cathode NEG− of the power supply 110. The second switch unit Q2 includes a second control end g2, a third conducting end d2, and a fourth conducting end s2. The second control end g2 is connected to the processor 120, and controls, under the control of the processor 120, the third conducting end d2 and the fourth conducting end s2 to be conducted or cut off, to implement conduction or disconnection of the second switch unit Q2. The second control end g2 receives the second control signal to control the third conducting end d2 and the fourth conducting end s2 to be conducted or cut off. The third conducting end d2 is connected to the second normally closed contact 132, and the fourth conducting end s2 is connected to the cathode NEG− of the power supply 110.

In this implementation manner, the first switch unit Q1 and the second switch unit Q2 are N-channel field effect transistors (N-channel Metal Oxide Semiconductor Field Effect Transistor (NMOSFET)), the first control end g1 and the second control end g2 are gates of the NMOSFETs, the first conducting end d1 and the third conducting end d2 are drains of the NMOSFETs, and the second conducting end s1 and the fourth conducting end s2 are sources of the NMOSFETs.

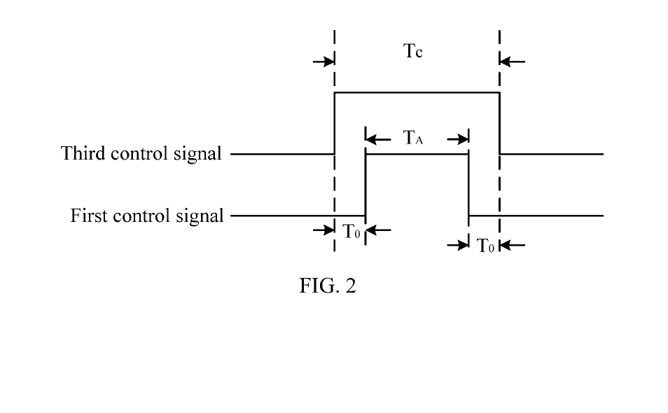

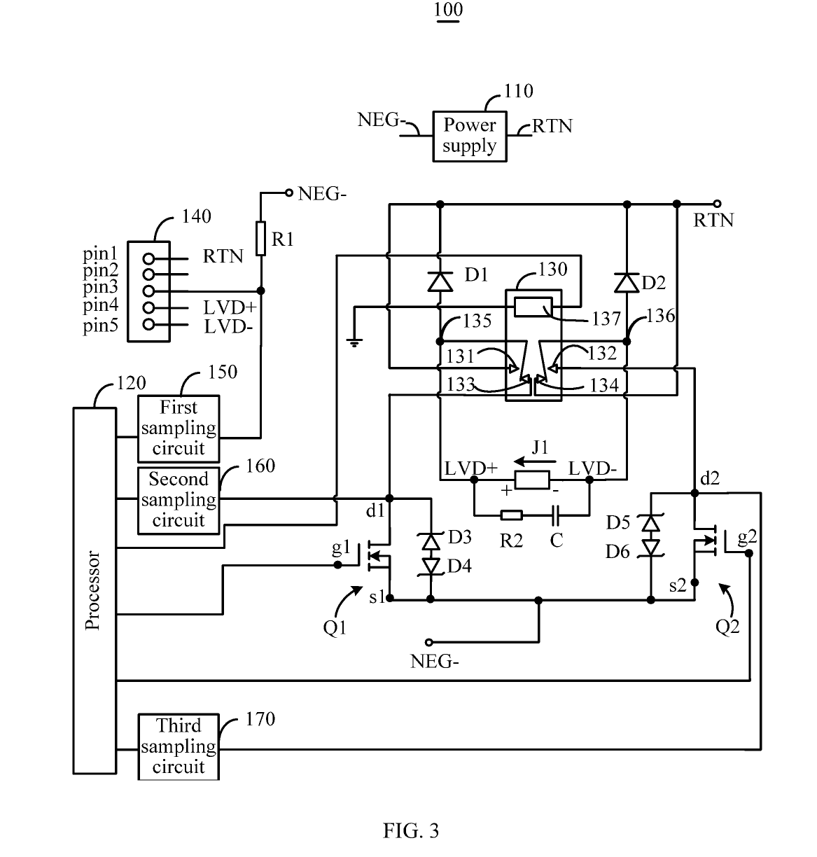

Referring to FIG. 2 and FIG. 3, FIG. 2 is a waveform diagram of a first control signal and a third control signal when a contactor drive circuit drives a bistable contactor according to the present disclosure, and FIG. 3 is a schematic diagram of a direction of current flow under the control of the control signals shown in FIG. 2 in a contactor drive circuit according to the present disclosure. When the first control signal controls the first switch unit Q1 to be conducted, the first control signal is a high-level signal with duration of T_{A}, a start time of the first control signal is a first start time, and an end time of the first control signal is a first end time. When the third control signal controls the first common contact 135 to be electrically connected to the first normally open contact 133 and the second common contact 136 to be electrically connected to the second normally open contact 134, the third control signal is a high-level signal with duration of T_{C}, a start time of the third control signal is a second start time, and an end time of the third control signal is a second end time. The first start time is a first time interval later than the second start time, and the second end time is a second time interval later than the first end time. Because the first start time is later than the second start time, after the third control signal controls the first common contact 135 to be electrically connected to the first normally open contact 133 and the second common contact 136 to be electrically connected to the second normally open contact 134, the first control signal then controls the first switch unit Q1 to be conducted. In this case, it avoids damage to the line connection and control unit 130 that is caused by sparking when the two common contacts of the line connection and control unit 130 are electrically connected to corresponding normally open contacts. Because the second end time is the second time interval later than the first end time, it avoids damage to the line connection and control unit 130 that is caused by sparking when the two common contacts of the relay are electrically connected to corresponding normally closed contacts. It may be understood that, the first time interval and the second time interval may be set and adjusted according to an actual situation.

In this implementation manner, the first control signal is a high-level pulse signal with duration T_{A} of 500 ms, and the third control signal is a high-level pulse signal with duration T_{C} of 900 ms. The first time interval is equal to the second time interval, both of which are 200 ms. The first control signal is generated after T₀=200 ms following generation of the third control signal; and after the first control signal ends, the third control signal further lasts for T₀=200 ms before end. When the first control signal is a high level signal, the first control signal controls the first switch unit Q1 to be conducted; and when the third control signal is a high level, the third control signal controls the first common contact 135 to be electrically connected to the first normally open contact 133 and the second common contact 136 to be electrically connected to the second normally open contact 134. When a coil of a bistable contactor is connected between the first drive end LVD+ and the second drive end LVD−, and further, when the first drive end LVD+ is connected to the anode of the drive coil of the bistable contactor J1, and the second drive end LVD− is connected to the cathode of the drive coil of the bistable contactor J1, the anode RTN of the power supply 110, the second normally open contact 134, the second common contact 136, the second drive end LVD−, the first drive end LVD+, the first common contact 135, the first normally open contact 133, the first switch unit Q1, and the cathode NEG− of the power supply 110 form a loop. In this case, as shown in FIG. 3, a current in the loop flows from the second drive end LVD− to the first drive end LVD+. In this case, a current on the drive coil of the bistable contactor J1 flows from the cathode of the drive coil to the anode of the drive coil. In this case, the bistable contactor J1 changes from a closed state to an open state.

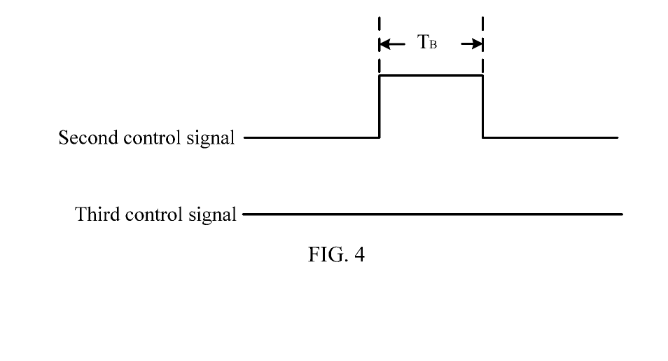

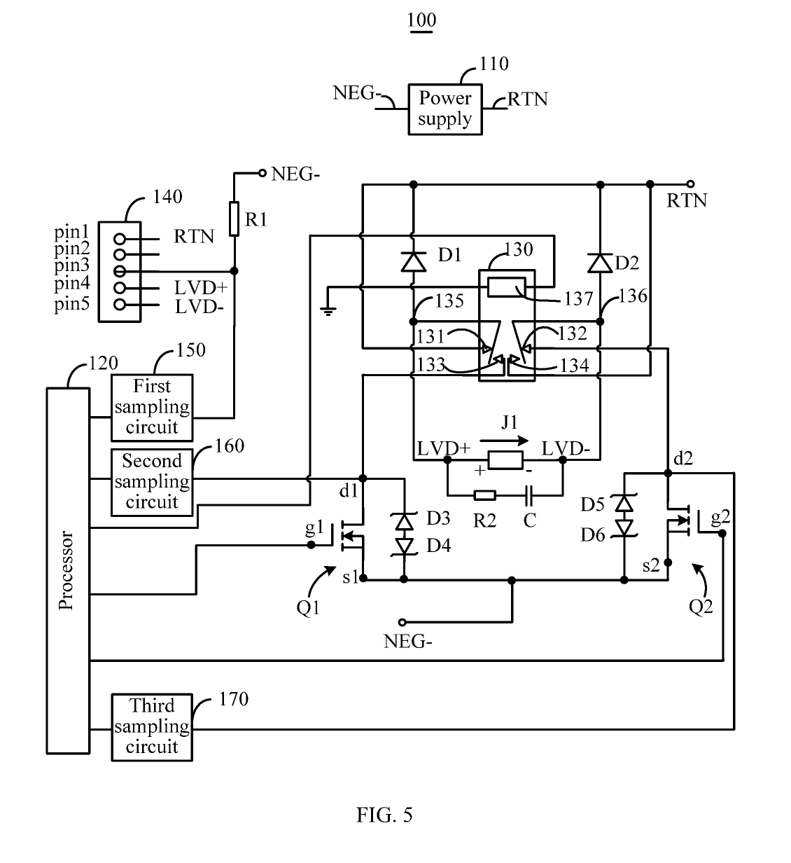

Referring to FIG. 4 and FIG. 5, FIG. 4 is a waveform diagram of a second control signal and a third control signal when a contactor drive circuit drives a bistable contactor according to the present disclosure, and FIG. 5 is a schematic diagram of a direction of current flow under the control of the control signals shown in FIG. 4 in a contactor drive circuit according to the present disclosure. As shown in FIG. 4, the second control signal is a high-level pulse signal with duration of T_{B}, and the third control signal is a low-level signal. In this implementation manner, the second control signal has duration T_{B} of 500 ms. In this case, the line connection and control unit 130 controls, under the control of the third control signal, the first common contact 135 to be electrically connected to the first normally closed contact 131 and the second common contact 136 to be electrically connected to the second normally closed contact 132. In this case, the second switch unit Q2 is conducted, and the first switch unit Q1 is in an open state. When the drive coil of the bistable contactor J1 is connected between the first drive end LVD+ and the second drive end LVD−, and further, when the first drive end LVD+ is connected to the anode of the drive coil of the bistable contactor J1, and the second drive end LVD− is connected to the cathode of the drive coil of the bistable contactor J1, the anode RTN of the power supply 110, the first normally closed contact 131, the first common contact 135, the first drive end LVD+, the second drive end LVD−, the second common contact 136, the second normally closed contact 132, the second switch unit Q2, and the cathode NEG− of the power supply 110 form a loop. In this case, as shown in FIG. 5, a current in the loop flows from the first drive end LVD+ to the second drive end LVD−. In this case, a current on the drive coil of the bistable contactor J1 flows from the anode of the drive coil to the cathode of the drive coil. In this case, the bistable contactor J1 changes from an open state to a closed state. As can be seen from the description of FIG. 2 to FIG. 5, the contactor drive circuit 100 can drive the bistable contactor.

The processor 120 controls the first common contact 135 to be electrically connected to the first normally closed contact 131 and the second common contact 136 to be electrically connected to the second normally closed contact 132, and controls the second switch unit Q2 to be conducted and the first switch unit Q1 to be disconnected, so as to control the normally closed contactor to switch from a third working state to a fourth working state. In addition, the processor 120 controls the first common contact 135 to be electrically connected to the first normally open contact 133 and the second common contact 136 to be electrically connected to the second normally open contact 134, and controls the first switch unit Q1 to be conducted and the second switch unit Q2 to be disconnected, so as to control the normally closed contactor to switch from the third working state to the fourth working state. The third working state is a closed state, and the fourth working state is an open state.

When the processor 120 determines that the type of the contactor connected between the first drive end LVD+ and the second drive end LVD− is a normally closed contactor, a principle of driving the normally closed contactor is introduced as follows.

When the type of the contactor connected between the first drive end LVD+ and the second drive end LVD− is a normally closed contactor J2, a coil of the normally closed contactor J2 is electrically connected between the first drive end LVD+ and the second drive end LVD−. When the second drive end LVD− is connected to the anode RTN of the power supply 110, the first control signal controls the first switch unit Q1 to be conducted, the second control signal controls the second switch unit Q2 to be disconnected, and the third control signal controls the first common contact 135 to be electrically connected to the first normally open contact 133 and the second common contact 136 to be electrically connected to the second normally open contact 134, a current, formed by the normally closed contactor J2 flows from the second drive end to the first drive end, and the normally closed contactor J2 changes from a closed state to an open state.

The start time of the first control signal is a third start time, the start time of the third control signal is a fourth start time, and the third start time is a third time interval later than the fourth start time.

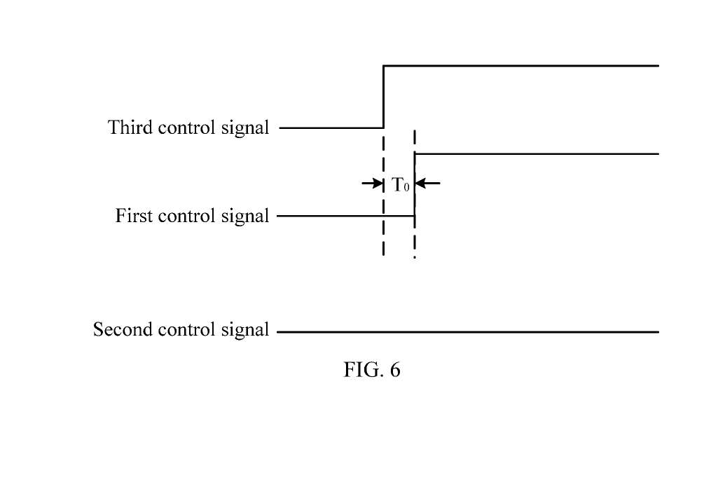

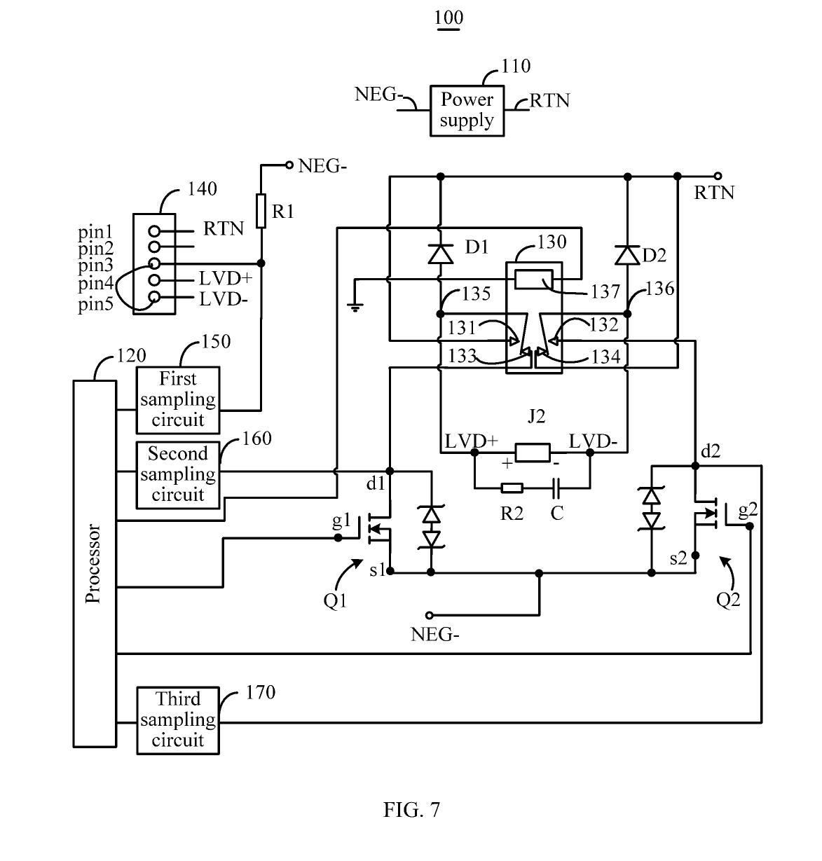

Referring to FIG. 6 and FIG. 7, FIG. 6 is a waveform diagram of a first control signal and a third control signal when a contactor drive circuit drives a normally closed contactor according to the present disclosure, and FIG. 7 is a schematic diagram of a direction of current flow under the control of the control signals shown in FIG. 6 in a contactor drive circuit according to the present disclosure. As shown in FIG. 6, the first control signal and the third control signal both are continuous high-level signals; in this case, the first control signal controls the first switch unit Q1 to be conducted, and the third control signal controls the first common contact 135 to be electrically connected to the first normally open contact 133 and the second common contact 136 to be electrically connected to the second normally open contact 134. As shown in FIG. 6, when the contactor drive circuit 100 drives the normally closed contactor J2, in this case, the second drive end LVD−, the first drive end LVD+, the first common contact 135, the first normally open contact 133, the first switch unit Q1, and the cathode NEG− of the power supply 110 form a loop. In this case, as shown in FIG. 7, a current in the loop flows from the second drive end LVD− to the first drive end LVD+. Because the normally closed contactor is driven between the first drive end LVD+ and the second drive end LVD−, the normally closed contactor is in a closed state in a case in which no current flows through the drive coil of the normally closed contactor, and the normally closed contactor switches from a closed state to an open state in a case in which a current flows through the coil of the normally closed contactor; and the normally closed contactor returns to a closed state when the coil of the normally closed contactor is powered off again. As can be seen from the description of FIG. 6 and FIG. 7, the contactor drive circuit 100 can drive the normally closed contactor. In this implementation manner, the start time of the first control signal is the third start time, the start time of the third control signal is the fourth start time, and the third start time is the third time interval later than the fourth start time. After the third control signal controls the first common contact 135 to be electrically connected to the first normally open contact 133 and the second common contact 136 to be electrically connected to the second normally open contact 134, then, after the third time interval, the first control signal controls the first switch unit Q1 to be conducted; therefore, it avoids damage to the line connection and control unit 130 that is caused by sparking when the two common contacts of the line connection and control unit 130 are electrically connected to corresponding normally open contacts. It may be understood that, the third time interval may be set and adjusted according to an actual situation. In this implementation manner, the third time interval is 200 ms.

As can be seen from the foregoing description, the contactor drive circuit 100 can drive two different types of contactors.

A principle of determining by the processor 120 whether the type of the driver connected between the first drive end LVD+ and the second drive end LVD− is a bistable contactor or a normally closed contactor is introduced as follows.

Referring to FIG. 1, FIG. 3, and FIG. 5 again, the contactor drive circuit 100 further includes a first resistor R1 and a first sampling circuit 150. One end of the first resistor R1 is connected to the cathode NEG− of the power supply 110, the other end of the first resistor R1 is connected to one end of the first sampling circuit 150, and the other end of the sampling circuit 150 is connected to the processor 120. In FIG. 1, FIG. 3, and FIG. 5, a third pin pin3 and a fifth pin pin5 of a connector 140 are electrically connected, so as to connect a node between the first resistor R1 and the first sampling circuit 150 to the anode RTN of the power supply 110. In an implementation manner, the third pin pin3 and the fifth pin pin5 of the connector 140 may be electrically connected by a metallic wire. Because the fifth pin pin5 of the connector 140 is electrically connected to the second drive end LVD−, after the third pin pin3 and the fifth pin pin5 of the connector 140 are electrically connected, voltages loaded on the third pin pin3 and the second drive end LVD− are equal. The first sampling circuit 150 detects a value of a current flowing through the first resistor R1, and transmits, to the processor 120, the detected value of the current flowing through the first resistor R1, and the processor 120 determines, according to the value of the current flowing through the first resistor R1, whether the contactor connected between the first drive end LVD+ and the second drive end LVD− is a normally closed contactor or a bistable contactor.

A detection principle is introduced as follows. When the contactor drive circuit 100 drives a bistable contactor, that is, the bistable contactor is connected between the first drive end LVD+ and the second drive end LVD−, because the third pin pin3 of the connector 140 is connected to the fifth pin pin5 of the connector 140, and the fifth pin pin5 of the connector 140 is connected to the second drive end LVD−, a voltage value of a voltage loaded on the node between the first resistor R1 and the first sampling circuit 150 and a voltage value of a voltage loaded on the second drive end LVD− are equal. In this case, the value of the current flowing through the first resistor R1 is equal to a value obtained after a resistance of the first resistor R1 is divided by a value, which is obtained by subtracting a voltage value of the cathode of the power supply 110 from the value of the voltage loaded on the second drive end LVD−. When the contactor drive circuit 100 drives the normally closed contactor, that is, the normally closed contactor is connected between the first drive end LVD+ and the second drive end LVD−, because the third pin pin3 of the connector 140 is connected to the fifth pin pin5 of the connector, the fifth pin pin5 of the connector 140 is connected to the second drive end LVD−, and the second drive end LVD− is connected to the anode RTN of the power supply 110. In this case, the value of the current flowing through the first resistor R1 is equal to a value obtained after a resistance of the first resistor is divided by a value, which is obtained by subtracting a voltage value of the cathode NEG− of the power supply 110 from a voltage value of the anode RTN of the power supply 110. The first sampling circuit 150 transmits, to the processor 120, the detected value of the current flowing through the first resistor R1. The processor 120 determines, according to the value of the current flowing through the first resistor R1, whether the contactor currently driven by the contactor drive circuit 100 is a normally closed contactor or a bistable contactor. It may be understood that, the value of the voltage loaded on the second drive end LVD− when the drive circuit 100 drives the bistable contactor is less than the value of the voltage loaded on the second drive end LVD− when the drive circuit 100 drives the normally closed contactor (in this case, the value of the voltage loaded on the second drive end LVD− is the value of the voltage of the anode RTN of the power supply 110). Therefore, the value of the current flowing through the first resistor R1 when the contactor drive circuit 100 drives the bistable contactor is less than the value of the current flowing through the first resistor R1 when the contactor drive circuit 100 drives the normally closed contactor. Therefore, in an implementation manner, the processor 120 may prestore a preset current value, where the preset current value is equal to the value of the current flowing through the first resistor R1 when the contactor drive circuit 100 drives the bistable contactor, or the preset current value is equal to the current flowing through the first resistor R1 when the contactor drive circuit 100 drives the normally closed contactor. When receiving the current value transmitted by the first sampling circuit 150 and indicating that a current flows through the first resistor R1, the processor may compare the preset current value with the current value transmitted by the first sampling circuit 150 and indicating that a current flows through the first resistor R1, to determine whether the contactor currently driven by the drive circuit 100 is a bistable contactor or a normally closed contactor.

The contactor trigger circuit 100 further includes a first diode D1 and a second diode D2, where an anode of the first diode D1 is connected to the first drive end LVD+, a cathode of the first diode D1 is connected to the anode RTN of the power supply 110. An anode of the second diode D2 is connected to the second drive end LVD−, and a cathode of the second diode D2 is connected to the anode RTN of the power supply 110. When a voltage of the anode of the first diode D1 is greater than a voltage of the cathode of the first diode D1, the first diode D1 is conducted; and when the voltage of the anode of the first diode D1 is less than the voltage of the cathode of the first diode D1, the first diode D1 is cut off. Similarly, when a voltage of the anode of the second diode D2 is greater than a voltage of the cathode of the second diode D2, the second diode D2 is conducted; and when the voltage of the anode of the second diode D2 is less than the voltage of the cathode of the second diode D2, the second diode D2 is cut off A diode has a unidirectional conduction feature, that is, when a voltage of an anode of the diode is greater than a voltage of a cathode of the diode, the diode is conducted; and when the voltage of the anode of the diode is less than the voltage of the cathode of the diode, the diode is cut off. In this implementation manner, because of the unidirectional conduction feature of the diodes, the first diode D1 breaks a path from the anode RTN of the power supply 110 to the first drive end LVD+, and the second diode D2 breaks a path from the anode RTN of the power supply 110 to the second drive end LVD−, so as to prevent the voltage of the anode RTN of the power supply 110 from being directly loaded on the first drive end LVD+ and the second drive end LVD−, and further avoid damage to an element located between the first drive end LVD+ and the second drive end LVD−.

The driver trigger circuit 100 further includes a first voltage regulator tube D3, a second voltage regulator tube D4, a third voltage regulator tube D5, and a fourth voltage regulator tube D6. A cathode of the first voltage regulator tube D3 is connected to a node between the first normally open contact 133 and the first conducting end d1, an anode of the first voltage regulator tube D3 is connected to an anode of the second voltage regulator tube D4, and a cathode of the second voltage regulator tube D4 is connected to the cathode NEG− of the power supply 110. When voltages loaded on two ends of the first switch unit Q1, that is, the first conducting end d1 and the second conducting end s1, are excessively large, the first voltage regulator tube D3 and the second voltage regulator tube D4 are broken down first, so as to protect the first switch unit Q1 that is connected to the first voltage regulator tube D3 and the second voltage regulator tube D4 in parallel, to prevent the first switch unit Q1 from burning out when the voltages on the two ends of the first switch unit Q1, that is, the first conducting end d1 and the second conducting end s1, are excessively large. A cathode of the third voltage regulator tube D5 is connected to a node between the second normally closed contact 132 and the third conducting end d2, an anode of the third voltage regulator tube D5 is connected to an anode of the fourth voltage regulator tube D6, and a cathode of the fourth voltage regulator tube D6 is connected to the cathode NEG− of the power supply 110. When voltages loaded on two ends of the second switch unit Q2, that is, the third conducting end d2 and the fourth conducting end s2, are excessively large, the third voltage regulator tube D5 and the fourth voltage regulator tube D6 are broken down first, so as to protect the second switch unit Q2 that is connected to the third voltage regulator tube D5 and the fourth voltage regulator tube D6 in parallel, to prevent the second switch unit Q2 from burning out when the voltages on the two ends of the second switch unit Q2, that is, the third conducting end d2 and the fourth conducting end s2, are excessively large.

The contactor drive circuit 100 further includes a second sampling circuit 160 and a third sampling circuit 170. One end of the second sampling circuit 160 is connected to the node between the first normally open contact 133 and the first conducting end d1 in the first switch unit Q1, and the other end of the sampling circuit 160 is connected to the processor 120. The second sampling circuit 160 collects a voltage signal that is at the node between the first normally open contact 133 and the first conducting end d1, to obtain a first voltage signal, and transmits the first voltage signal to the processor 120. One end of the third sampling circuit 170 is connected to a node between the second normally closed contact 132 and the third conducting end d2 of the second switch unit Q2, and the other end of the third sampling circuit 170 is connected to the processor 120. The third sampling circuit 170 collects a voltage signal that is at the node between the second normally closed contact 132 and the third conducting end d2 of the second switch unit Q2, to obtain a second voltage signal, and transmits the second voltage signal to the processor 120. The processor 120 compares the first voltage signal with a first preset voltage signal prestored in the processor 120, to determine whether the first switch unit Q1 is faulty, and compares the second voltage signal with a second preset voltage signal prestored in the processor 120, to determine whether the second switch unit Q2 is faulty. The first preset voltage signal is a voltage signal representing that the first switch unit Q1 works normally, and the second preset voltage signal is a voltage signal representing that the second switch unit Q2 works normally. When detecting that the first switch unit Q1 or the second switch unit Q2 is faulty, the processor 120 adjusts the first control signal, the second control signal, and the third control signal, to cut off a loop required to be formed to drive the contactor, so as to protect the contactor connected between the first drive end LVD+ and the second drive end LVD−. For example, when the second switch unit Q2 is faulty, the third conducting end d2 and the fourth conducting end d3 are short-circuited; in this case, the anode RTN of the power supply 110 and the cathode NEG− of the power supply 110 form a loop. Because the bistable contactor or the normally closed contactor has a very small resistance, and easily burns out, voltage signals of the first switch unit Q1 and the second switch unit Q2 are collected to determine as soon as possible whether the first switch unit Q1 or the second switch unit Q2 is faulty; and after it is determined that the first switch unit Q1 or the second switch unit Q2 is faulty, a loop required to be formed to drive the contactor is cut off, so as to protect the contactor between the first drive end LVD+ and the second drive end LVD−.

In an implementation manner, the contactor drive circuit 100 further includes a second resistor R2 and a capacitor C, where one end of the second resistor R2 is connected to the first drive end LVD+, and the other end of the second resistor R2 connects the capacitor C to the second drive end LVD−. The second resistor R2 and the capacitor C are configured to protect the contactor disposed between the first drive end LVD+ and the second drive end LVD−.

In this implementation manner, the power supply 110, the processor 120, the line connection and control unit 130, the first resistor R1, the second resistor R2, the capacitor C, the first switch unit Q1, the second switch unit Q2, the first diode D1, the second diode D2, the first voltage regulator tube D3, the second voltage regulator tube D4, the third voltage regulator tube D5, and the fourth voltage regulator tube D6 are integrated on a circuit board. The first drive end LVD+ and the second drive end LVD− are two jacks on the circuit board, and the normally closed contactor or the bistable contactor is connected to the two jacks, that is, the first drive end LVD+ and the second drive end LVD−, on the circuit board using the connector 140.

During actual application, the contactor drive circuit 100 in the present disclosure first detects the type of the contactor located between the first drive end LVD+ and the second drive end LVD−, and then performs corresponding drive according to whether the contactor located between the first drive end LVD+ and the second drive end LVD− is a bistable contactor or a normally closed contactor. When detecting that the contactor located between the first drive end LVD+ and the second drive end LVD− is a normally closed contactor, the processor 120 in the drive circuit 100 in the present disclosure performs drive according to the foregoing policy of driving the normally closed contactor. When the processor 120 in the drive circuit 100 detects that the contactor located between the first drive end LVD+ and the second drive end LVD− is a bistable contactor, because the bistable contactor further includes an auxiliary contact (not shown in the diagrams), and the auxiliary contact of the bistable contactor indicates whether a current working state of the bistable contactor is a closed state or an open state, such that the bistable contactor can transmit the current working state of the bistable contactor to the processor 120, then, the processor 120 controls the bistable contactor according to an actual application requirement and the current working state of the bistable contactor.

According to the contactor drive circuit 100 provided in the present disclosure, a processor 120 first determines a type of a contactor connected between a first drive end LVD+ and a second drive end LVD−. Then the processor 120 controls, according to a result of the determining, a line connection and control unit 130 to enable the first drive end LVD+ to be electrically connected to an anode RTN of a power supply 110, and controls the second drive end LVD− to be connected to a cathode NEG− of the power supply 110; when the contactor is connected between the first drive end LVD+ and the second drive end LVD−, a current flowing from the first drive end LVD+ to the second drive end LVD− is formed. Alternatively, the processor 120 controls the line connection and control unit 130 to enable the second drive end LVD− to be electrically connected to the anode RTN of the power supply 110, and controls the first drive end LVD+ to be electrically connected to the cathode NEG− of the power supply 110; when the contactor is connected between the first drive end LVD+ and the second drive end LVD−, a current flowing from the second drive end LVD− to the first drive end LVD+ is formed. In this way, two different types of contractors, that is, a bistable contactor and a normally closed contactor, can be driven. Therefore, a technical effect that one drive circuit drives two different types of contactors is achieved.

Further, the contactor drive circuit 100 provided in the present disclosure can further determine, according to a value of a current flowing through a first resistor R1, whether the contactor currently connected between the first drive end LVD+ and the second drive end LVD− is a bistable contactor or a normally closed contactor, achieving a technical effect of determining the type of the currently driven contactor.

Still further, in the contactor drive circuit 100 provided in the present disclosure, a second sampling circuit 160 and a third sampling circuit 170 respectively collect voltage values of a first switch unit Q1 and a second switch unit Q2, to determine whether the first switch unit Q1 and the second switch unit Q2 are faulty. When the first switch unit Q1 and the second switch unit Q2 are faulty, the processor 120 adjusts a first control signal, a second control signal, and a third control signal, to cut off a loop generated by the control signals, so as to protect the contactor located between the first drive end LVD+ and the second drive end LVD−, thereby achieving a technical effect of protecting the contactor between the first drive end LVD+ and the second drive end LVD− when the first switch unit Q1 or the second switch unit Q2 is faulty.

What is disclosed above is merely exemplary embodiments of the present disclosure, and is not intended to limit the protection scope of the present disclosure. A person of ordinary skill in the art may understand that all or some of processes that implement the foregoing embodiments and equivalent modifications made in accordance with the claims of the present disclosure shall fall within the scope of the present disclosure.

What is claimed is:

1. A contactor drive circuit configured to drive a bistable contactor or a normally closed contactor, wherein the contactor drive circuit comprises:
a power supply;
a processor;
a line connection and control unit;
a first drive end; and
a second drive end,
wherein the first drive end and the second drive end are configured to drive the bistable contactor or the normally closed contactor,
wherein the processor is electrically connected to the line connection and control unit,
wherein, when a contactor is connected between the first drive end and the second drive end, the processor determines, according to a value of a current flowing through the contactor, a type of the contactor connected between the first drive end and the second drive end, and
wherein, according to a result of the determining, the processor controls the line connection and control unit to enable the first drive end to be electrically connected to an anode of the power supply and controls the second drive end to be electrically connected to a cathode of the power supply, or the processor controls the line connection and control unit to enable the second drive end to be connected to the anode of the power supply and controls the first drive end to be electrically connected to the cathode of the power supply.

2. The contactor drive circuit according to claim 1, wherein the contactor drive circuit further comprises a first switch unit and a second switch unit, wherein the first switch unit and the second switch unit are electrically connected to the processor, and wherein the processor controls the second switch unit to be conducted and the first switch unit to be disconnected, to control the second drive end to be electrically connected to the cathode of the power supply, or the processor controls the first switch unit to be conducted and the second switch unit to be disconnected, to control the first drive end to be connected to the cathode of the power supply.

3. The contactor drive circuit according to claim 2, wherein the line connection and control unit is a relay, wherein the relay comprises a first normally closed contact, a second normally closed contact, a first normally open contact, a second normally open contact, a first common contact, a second common contact, and a coil, wherein the first normally closed contact and the second normally open contact are connected to the anode of the power supply, wherein the first normally open contact is connected to the cathode of the power supply using the first switch unit, wherein the second normally closed contact is connected to the cathode of the power supply using the second switch unit, wherein the first common contact is connected to the first drive end, wherein the second common contact is connected to the second drive end, wherein one end of the coil is electrically connected to the processor and the other end of the coil is grounded, wherein, when the contactor is connected between the first drive end and the second drive end, the processor determines, according to the value of the current flowing through the contactor, the type of the contactor connected between the first drive end and the second drive end, and wherein, according to the result of the determining, the processor controls the first common contact to be electrically connected to the first normally closed contact and the second common contact to be electrically connected to the second normally closed contact, such that the first drive end is electrically connected to the anode of the power supply, or the processor controls the first common contact to be electrically connected to the first normally open contact and the second common contact to be electrically connected to the second normally open contact, such that the second drive end is electrically connected to the anode of the power supply.

4. The contactor drive circuit according to claim 3, wherein, when the processor determines that the type of the contactor connected between the first drive end and the second drive end is a bistable contactor, wherein the bistable contactor comprises an auxiliary contact, and wherein the auxiliary contact indicates a current working state of the bistable contactor, the processor controls, according to the current working state of the bistable contactor, the first common contact to be electrically connected to the first normally closed contact and the second common contact to be electrically connected to the second normally closed contact and controls the second switch unit to be conducted and the first switch unit to be disconnected, to control the bistable contactor to switch from a first working state to a second working state, and the processor controls, according to the current working state of the bistable contactor, the first common contact to be electrically connected to the first normally open contact and the second common contact to be electrically connected to the second normally open contact and controls the first switch unit to be conducted and the second switch unit to be disconnected, to control the bistable contactor to switch from the second working state to the first working state.

5. The contactor drive circuit according to claim 3, wherein a signal used for the processor to control the first switch unit is a first control signal, wherein, when the first control signal controls the first switch unit to be conducted, a start time of the first control signal is a first start time and an end time of the first control signal is a first end time, wherein a signal used for the processor to control the relay is a third control signal, wherein, when the third control signal controls the first common contact to be electrically connected to the first normally open contact and the second common contact to be electrically connected to the second normally open contact, a start time of the third control signal is a second start time and an end time of the third control signal is a second end time, wherein the first start time is a first time interval later than the second start time, and wherein the second end time is a second time interval later than the first end time.

6. The contactor drive circuit according to claim 5, wherein the first time interval is equal to the second time interval.

7. The contactor drive circuit according to claim 6, wherein the first time interval and the second time interval are 200 milliseconds (ms).

8. The contactor drive circuit according to claim 3, wherein, when the processor determines that the type of the contactor connected between the first drive end and the second drive end is a normally closed contactor, the processor controls the first common contact to be electrically connected to the first normally closed contact and the second common contact to be electrically connected to the second normally closed contact and controls the second switch unit to be conducted and the first switch unit to be disconnected, to enable the second drive end to be connected to the cathode of the power supply, so as to drive the normally closed contactor, or the processor controls the first common contact to be electrically connected to the first normally open contact and the second common contact to be electrically connected to the second normally open contact and controls the first switch unit to be conducted and the second switch unit to be disconnected, to enable the first drive end to be connected to the cathode of the power supply, so as to drive the normally closed contactor.

9. The contactor drive circuit according to claim 8, wherein a signal used for the processor to control the first switch unit is a first control signal, wherein, when the first control signal controls the first switch unit to be conducted, the start time of the first control signal is a third start time, wherein a signal used for the processor to control the relay is a third control signal, wherein, when the third control signal controls the first common contact to be electrically connected to the first normally open contact and the second common contact to be electrically connected to the second normally open contact, the start time of the third control signal is a fourth start time, and wherein the third start time is a third time interval later than the fourth start time.

10. The contactor drive circuit according to claim 9, wherein the third time interval is 200 ms.

11. The contactor drive circuit according to claim 1, wherein the contactor drive circuit further comprises a first resistor and a first sampling circuit, wherein one end of the first resistor is connected to the cathode of the power supply, wherein the other end of the first resistor is connected to one end of the first sampling circuit, wherein the other end of the first sampling circuit is connected to the processor, wherein a node between the first resistor and the first sampling circuit is connected to the anode of the power supply, wherein the first sampling circuit detects a value of a current flowing through the first resistor and transmits, to the processor, the detected value of the current flowing through the first resistor, and wherein the processor determines, according to the value of the current flowing through the first resistor, whether the contactor currently driven by the contactor drive circuit is a normally closed contactor or a bistable contactor.

12. The contactor drive circuit according to claim 3, wherein the first switch unit comprises a first control end, a first conducting end, and a second conducting end, wherein the first control end is connected to the processor, and controls, under the control of the processor, the first conducting end and the second conducting end to be conducted or cut off, to implement conduction or disconnection of the first switch unit, wherein the first conducting end is connected to the first normally open contact, and wherein the second conducting end is connected to the cathode of the power supply.

13. The contactor drive circuit according to claim 12, wherein the contactor drive circuit further comprises a first voltage regulator tube and a second voltage regulator tube, wherein a cathode of the first voltage regulator tube is connected to a node between the first normally open contact and the first conducting end, wherein an anode of the first voltage regulator tube is connected to an anode of the second voltage regulator tube, and wherein a cathode of the second voltage regulator tube is connected to the cathode of the power supply.

14. The contactor drive circuit according to claim 12, wherein the first switch unit is an N-channel field effect transistor, wherein the first control end is a gate of the N-channel field effect transistor, wherein the first conducting end is a drain of the N-channel field effect transistor, and wherein the second conducting end is a source of the N-channel field effect transistor.

15. The contactor drive circuit according to claim 3, wherein the second switch unit comprises a second control end, a third conducting end, and a fourth conducting end, wherein the second control end is connected to the processor, and controls, under the control of the processor, the third conducting end and the fourth conducting end to be conducted or cut off, to implement conduction or disconnection of the second switch unit, wherein the third conducting end is connected to the second normally closed contact, and wherein the fourth conducting end is connected to the cathode of the power supply.

16. The contactor drive circuit according to claim 15, wherein the contactor drive circuit further comprises a third voltage regulator tube and a fourth voltage regulator tube, wherein a cathode of the third voltage regulator tube is connected to a node between the second normally closed contact and the third conducting end, wherein an anode of the third voltage regulator tube is connected to an anode of the fourth voltage regulator tube, and wherein a cathode of the fourth voltage regulator tube is connected to the cathode of the power supply.

17. The contactor drive circuit according to claim 15, wherein the second switch unit is an N-channel field effect transistor, wherein the second control end is a gate of the N-channel field effect transistor, wherein the third conducting end is a drain of the N-channel field effect transistor, and wherein the fourth conducting end is a source of the N-channel field effect transistor.

18. The contactor drive circuit according to claim 1, wherein the contactor drive circuit further comprises a first diode, wherein an anode of the first diode is connected to the first drive end, and wherein a cathode of the first diode is connected to the anode of the power supply.

19. The contactor drive circuit according to claim 1, wherein the contactor drive circuit further comprises a second diode, wherein an anode of the second diode is connected to the second drive end, and wherein a cathode of the second diode is connected to the anode of the power supply.

20. The contactor drive circuit according to claim 3, wherein the contactor drive circuit further comprises a second sampling circuit, wherein the second sampling circuit is electrically connected between the processor and a node between the first switch unit and the first normally open contact, to collect a first voltage signal that is at the node between the first normally open contact and the first switch unit, wherein the second sampling circuit transmits the first voltage signal to the processor, wherein the processor compares the first voltage signal with a first preset voltage signal prestored in the processor, to determine whether the first switch unit is faulty, and wherein the first preset voltage signal is a voltage signal representing that the first switch unit works normally.

21. The contactor drive circuit according to claim 3, wherein the contactor drive circuit further comprises a third sampling circuit, wherein the third sampling circuit is electrically connected between the processor and a node between the second switch unit and the second normally closed contact, to collect a second voltage signal that is at the node between the second normally closed contact and the second switch unit, wherein the third sampling circuit transmits the second voltage signal to the processor, wherein the processor compares the second voltage signal with a second preset voltage signal prestored in the processor, to determine whether the second switch unit is faulty, and wherein the second preset voltage signal is a voltage signal representing that the second switch unit works normally.
